(19) United States
(12) Patent Application Publication
(10) Pub. No.: US 2015/0010736 A1
(43) Pub. Date: Jan. 8, 2015

(54) STRETCHABLE TAPE FLAG

(71) Applicant: 3M INNOVATIVE PROPERTIES COMPANY, St. Paul, MN (US)

(72) Inventors: Sayuki Aiura, Kanagawa (JP); Makoto Sasaki, Shizuoka (JP)

(21) Appl. No.: 14/380,656

(22) PCT Filed: Feb. 28, 2013
(86) PCT No.: PCT/US13/28349

§ 371 Date: Aug. 22, 2014

(30) Foreign Application Priority Data
Feb. 28, 2012 (JP) 2012-041578

(51) Int. Cl. B42D 9/00; B42F 21/06

(52) U.S. Cl. CPC B42D 9/004; B42F 21/06
USPC 428/195.1; 428/343

(57) ABSTRACT

A stretchable tape flag, wherein a backing layer has a stretchable portion capable of being stretched by hand and has elastic and plastic deformation characteristics on at least one portion; an adhesive layer capable of reapplication and placed on at least part of one side of the backing layer; and stuck on the object with the stretchable portion of the backing layer extended.

### TECHNOLOGICAL FIELD

The present invention relates to a stretchable tape flag which can be used as an index marker.

### BACKGROUND

A film-shaped polymer base material or backing, wherein an tape flag coated with an adhesive capable of reapplication without reapplying the adhesive to the area, sometimes referred to as index markers or book marks, which are used to mark pages of books, documents or the like, by being applied thereon, and may be used as an index marker. Illustrative examples are disclosed in Japanese Patent Laid-Open Application No. 4-504004 and U.S. Pat. No. 5,283,091.

There are many instances where since the back material is colored, the tape flags are designed so that the area to be applied with an adhesive is transparent or semitransparent, and this allows them to stand out and be used as a marker or an index marker, and also allows the covered words or characters to be seen since the material is transparent.

A tape flag itself of such a method of application, which is very convenient as a page marker or index marker are commonly and effectively used to mark, e.g., a specific page out of a stack or book, but cannot similarly mark the exact location on the page. Accordingly, users typically use a second flag or other means to indicate the desired location on the page which is marked by the first tape flag.

The need exists for a tape flag that readily indicates to a user a location on a sheet or article surface.

### SUMMARY OF THE INVENTION

The present invention provides tape flags that can simultaneously both (1) mark a selected page in a set of pages, e.g., stack of documents in a file, a book, etc., and (2) mark a selected specific location on the page.

In accordance with the invention, in typical embodiments stretchable tape flags of the invention comprise a base material or backing layer having a stretchable portion capable of being stretched by hand on at least one portion; and an adhesive layer capable of reapplication disposed at least partially on one side of the backing layer. In use, the sheet can be applied to and stuck on a desired object with the stretchable portion of the backing layer extended.

Since the stretchable tape flag of the present invention can be stuck on articles such as pages, photographs, etc. in books, files, or the like, with the stretchable portion of the backing layer in the extended position, it can show both (1) a specific page as an index marker and (2) a specific location on the index marked article.

### BRIEF DESCRIPTION OF THE DRAWINGS

The invention is further explained with reference to the drawing wherein:

FIG. 1A is a perspective view of a stretchable tape flag according to a first illustrative embodiment of the invention;

FIG. 1B is a perspective view of a stretchable tape flag according to a second illustrative embodiment of the invention;

FIGS. 2A, 2B, and 2C are perspective views of still other illustrative embodiments of stretchable tape flags of the invention;

FIG. 3 is a schematic view showing an illustrative stretchable tape flag of the invention applied to a page in a book;

FIGS. 4A-4C are a series of schematic views showing an illustrative method of applying a stretchable tape flag to the page in a book and indicating a selected location on the page in accordance with the invention;

FIGS. 5A-5C are top views of other illustrative embodiments of stretchable tape flags of the invention;

FIGS. 6A-6C are top views of still other illustrative embodiments of stretchable tape flags of the invention; and

FIGS. 7A-7C are perspective views of illustrative embodiments of stretchable tape flags of the invention.

These figures are not to scale and are intended to be merely illustrative and not limiting. Like numbers are used to refer to like members.

### DETAILED DESCRIPTION OF ILLUSTRATIVE EMBODIMENTS OF THE INVENTION

The stretchable tape flag according to the embodiments of the present invention comprises a base material or backing layer having a stretchable portion capable of being stretched by hand and adhesive on at least a portion of one side of the backing layer. The adhesive may be in the form of a continuous layer covering at least a portion or all of the one side of the backing layer, or it may be an array of segments on the one side.

The backing layer, in its entirety or only one or more portions thereof, is stretchable by hand and exhibits either elastic yield or sufficiently low recovery force that once stretched and adhered to at least two locations on the article it will remain in desired location without detaching from the article undersirably. Thus, when applied to an article, e.g., a page or photograph, in accordance with the invention, the tape flag will remain in place with a first portion adhered to the article at an edge thereof with a portion extending therebeyond to provide the indexing function as well as with a second portion adhered to the article at a selected location on the surface thereof. Adhesive on the one side of the backing layer should be present across sufficient portion of the backing layer that the backing layer can undergo desired stretching for use herein with the tape flag having adhesive in appropriate locations to provide points of attachment on either side of the stretched portion of backing.

In some preferred embodiments where suitable adhesive has been selected, the backing layer exhibits durable elastic recovery such that it can be removed from one or more points of attachment to the article and then used to indicate a different portion of the article, e.g., a different location on the same page, and/or used on a different article, e.g., a page in another book.

The backing layer may exhibit substantially uniform stretch and elastic recovery properties across essentially its entirety or have segments of differing properties. For instance, the respective ends may be substantially unstretchable with the requisite stretchable portion therebetween provide that the adhesive is present at least nearer the respective ends of the tape flag as the stretchable portion.

Such an tape flag with extension properties (stretchable tape flag), can be applied on the object as an index marker (i.e., referred to herein as the “indexing location” near the edge of the article where the tape flag preferably extends beyond the edge), stretched to elongate the stretchable portion of the backing layer as desired, and the tape marker adhered to the article at a second location (i.e., referred to herein as the “locating portion” where the tape flag is positioned to draw attention to a feature on the article). Thus, the invention provides easy, effective indexing of an article as is known in the art with the further, heretofore unknown benefit, of also indicating a select, specific location of a written passage or photograph image on a page. The dual functionality of tape flags of the invention (i.e., “indexing” and “locating”) can eliminate the need to annotate pages with writing instruments, thereby avoiding undesirable impairment or damage to documents, etc.

In some embodiments, it is preferable that the adhesive be in discontinuous portions with stretchable portion of the backing layer therebetween. In such embodiments, the tape flag is securely adhered to the article, e.g., page, at both the indexing location and the locating location, but the intermediate portion of the tape flag can be manipulated, e.g., pulled to the side, so as not to obscure other portions of the page while still leaving the tape flag securely adhered thereto.

If desired, portions or all of the backing material may adapted to be sufficiently clear to permit reading therethrough, have legends or color thereon to enhance the sophistication of marking, be writable.

Depending upon the size of the tape flag, in some instances, it is desirable for the stretchable portion of the backing layer to be capable of being extended at least 100% in one direction. If the stretchable tape flag can be extended at least 100% (when the stretchable portion has been extended so as to be at least twice as long), then it should be able to reach, for example, the reference point of an article or photograph located in the central portion of a magazine or an A-4 size document, or the like. As will be understood, stretchable tape flags of the invention can be made in selected dimensions with selected materials to be adapted for use on articles of desired size. For instance, larger, more extensible embodiments might be made for use with large format books whereas smaller, less extensible embodiments will be well suited for use with small pocket-size books.

For the stretchable portion of the backing layer, it is preferable for the stress when being extended 100% to be less than about 15 MPa, and more preferable to be less than about 12 MPa. If the stress is as described above, the user can easily extend the stretchable portion of the backing layer by hand. Illustrative examples of suitable backing layer materials include are single or co-polymer polyefins and polyethylenes. These materials are stretchable and possess plastic and deformation characteristics and are suitable as the backing layer of the stretchable tape flag.

In some embodiments, it is preferable that the adhesive be in discontinuous portions with stretchable portion of the backing layer therebetween. The function as the guide and index marker can be improved by attaching the area where the adhesive layer is not formed so that it extends out from the object. Note that, the backing layer of the area where the adhesive layer is not formed can be given color, and the design can be formed to give a particular shape (for example, in the shape of a flower or animal), and thereby improving convenience. Hereinafter, these and other advantages and features of the present invention will become better understood upon consideration of the following detailed description of the invention when considered in connection with the accompanying drawings. Note that, like reference numerals designate like parts throughout the figures and therefore their descriptions have been eliminated.

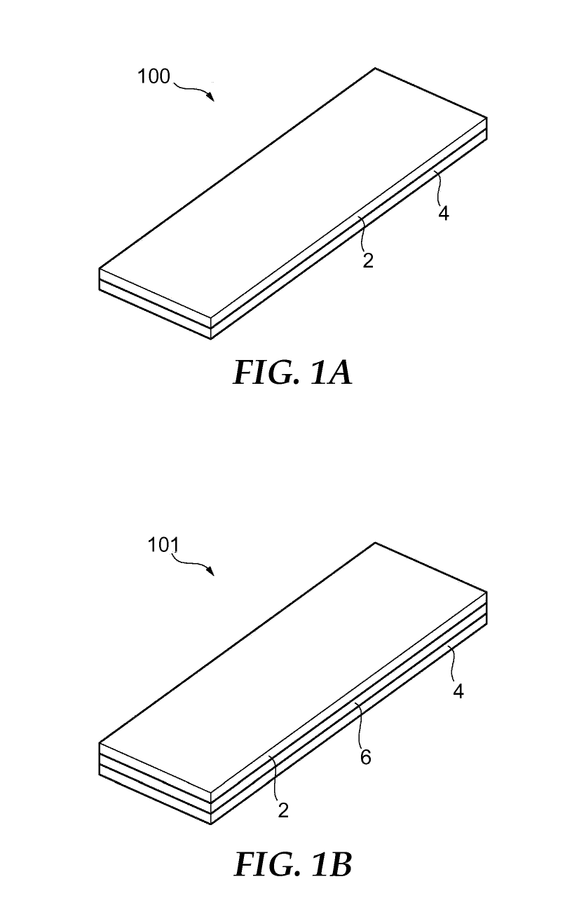

FIG. 1A is a perspective view of the stretchable tape flag 100 according to the first embodiment, and FIG. 1B is a perspective view of stretchable tape flag 101 according to the second embodiment. The stretchable tape flag 100 shown in FIG. 1A has a backing layer 2 and an adhesive layer 4 capable of being detached and reattached and formed over the entire surface of one side of the backing layer 2. The stretchable tape flag 101 shown in FIG. 1B has a primer layer 6 to improve adhesive property of both layers between the backing layer 2 and the adhesive layer 4, and the rest of the configuration is the same as the first embodiment. In the embodiments shown in both FIGS. 1A and 1B, substantially all of backing layer 2 is stretchable with the desired plastic and deformation characteristics so the user can extend it easily by hand.

As one example of the above described, the stretchable tape flags 100 and 101, after one end has been stuck on the object, the other end can be extended and attached to the objective location, however only the backing layer 2 of the portion between one end and the other end can be made so the user can extend it easily by hand and that the stretchable portion has plastic and deformation characteristics.

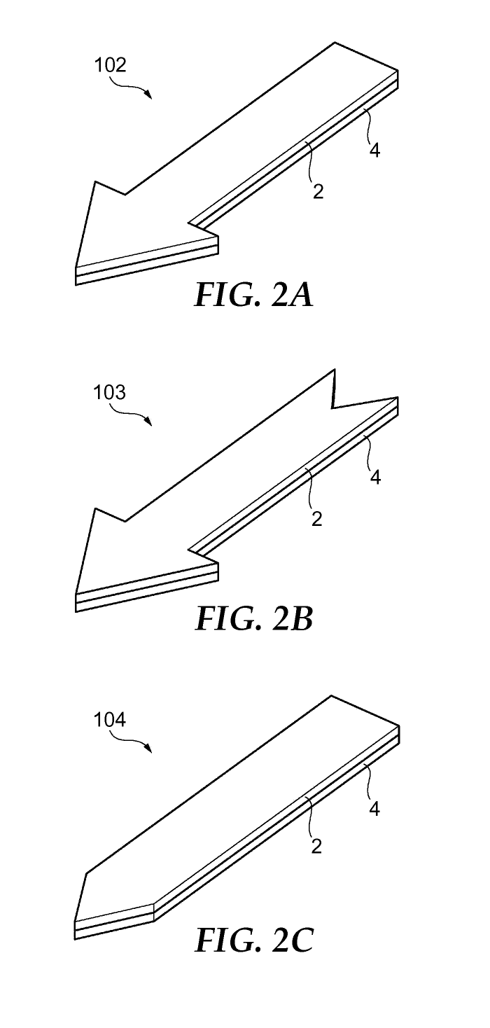

FIG. 2A is a perspective view of a stretchable tape flag 102 according to the third embodiment,

FIG. 2B is a perspective view of a stretchable tape flag 103 according to the fourth embodiment, and

FIG. 2C is a perspective view of a stretchable tape flag 104 according to the fifth embodiment. The stretchable tape flag 102 is configured such that one end of the backing layer 2 and the adhesive layer 4 are in the shape of an arrow to enhance its impact at the locating location, and the rest of the configuration is the same as the first embodiment. The stretchable tape flag 103 is configured such that one end of the backing layer 2 and the adhesive layer 4 are in the shape of an arrow, a notch is provided in the other end, and the rest of the configuration is the same as the first embodiment. In addition, the stretchable tape flag 104 has one end that is in the shape of an arrow which is different from the third embodiment, and the rest of the configuration is the same as the first embodiment. In all of these embodiments, the point that at least one part of the backing layer 2 can be made so the user can extend it easily by hand and that the stretchable portion having plastic and deformation characteristics is also similar to the first embodiment, and a primer layer can be provided between the backing layer 2 and adhesive layer 4 in the same manner as the second embodiment. With regards to the design of the end of such a stretchable tape flag, innumerable designs can be considered and these designs are in no way limited to the embodiments. The whole stretchable tape flag shape are typically a long paper-shaped strip, and for example, are 3 mm to 20 mm in width and preferably 10 mm to 15 mm in width, and 20 mm to 150 mm in length, and more preferably 30 mm to 80 mm in width. However, various kinds of forms as well as long film-shaped shape can be used and the width and length are not particularly limited hereto.

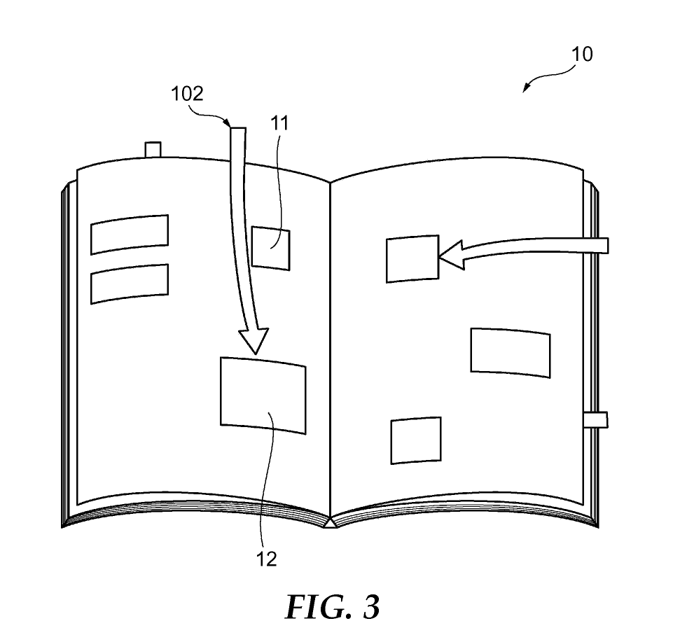

FIG. 3 is a drawing showing an example of the stretchable tape flag 102 in use. As shown in FIG. 3, for example, when the stretchable tape flag 102 is stuck on a book, the stretchable tape flag 102 is stuck on the book 10 which has an article 11 and a photograph 12 and the end which has a formed arrow is arranged so as to point to the photograph 12 and the other rectangle end is arranged to protrude from book 10 and functions as a marker. The stretchable tape flag 102 which was extended and stuck on the position of the object to be shown, maintains its extended state due to the lasting plastic and deformation characteristics of the stretchable portion of the backing.

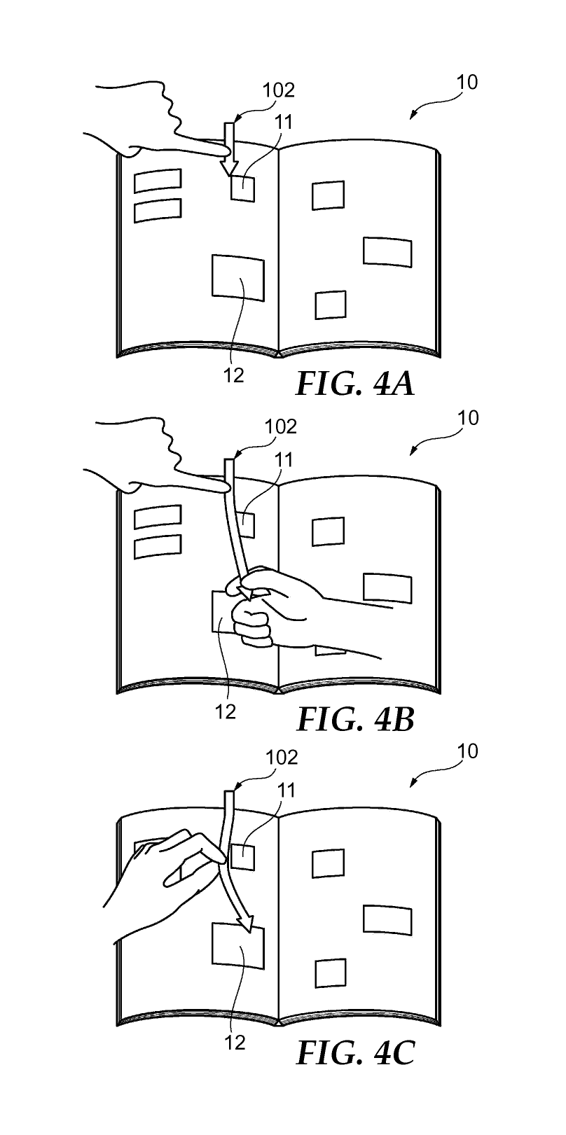

FIGS. 4A-4C are drawings showing examples of the usage of stretchable tape flag 102. As shown in FIG. 4, when the stretchable tape flag 102 is stuck on the book 10 while being extended for example, as shown in FIG. 4A, first, the rectangular end protrudes from the book 10 and adheres the stretchable tape flag 102 to edge of the book 10, i.e., the indexing location. Next, as shown in FIG. 4B, the end of the arrow shape is held, the stretchable portion of the backing layer of stretchable tape flag 102 is extended by hand to the photograph 12 which is an objective point to be marked. Then, as shown in FIG. 4C, the central part of stretchable tape flag 102 is moved and stuck on a position as needed so as not to obscure photograph 11. Note that, when the photograph 11 of book 10 and the photograph 12 can be seen through the backing layer and adhesive layer, it isn't always necessary to change the position of the central part of stretchable tape flag 102.

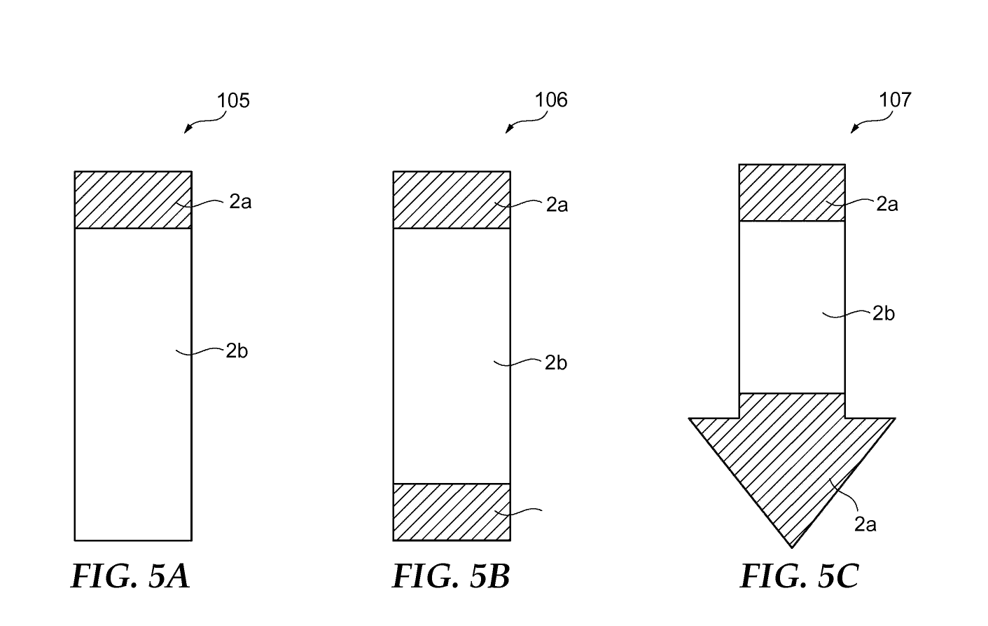

FIG. 5 is a drawing showing an example when only a part of the backing layer of the stretchable tape flag is a stretchable portion with plastic and deformation characteristics. FIG. 5A is a schematic top view of the stretchable tape flag 105 according to the sixth embodiment in which a part excluding the backing layer end 2a becomes the stretchable portion 2b. FIG. 5B is a schematic top view of the stretchable tape flag 106 according to the seventh embodiment in which a part excluding the backing layer ends 2a becomes the stretchable portion 2b. FIG. 5C is a schematic top view of the stretchable tape flag 108 according to the eighth embodiment in which one end of the backing layer in the seventh embodiment is in the shape of an arrow. Note that, there are various kinds of methods to make only a part of the backing layer stretchable portion in this way, however for example, a configuration can be taken where the stretchable portion and the base of the backing layer can be formed in the layer of the same material, and the material layer which does not have plastic and deformation characteristics at one or both ends can be layered through the adhesive layer and the adhesion layer. Note that, the ends 2a of the backing layer can be given coloration or a design to enhance their functionality as indexing and locating indicators.

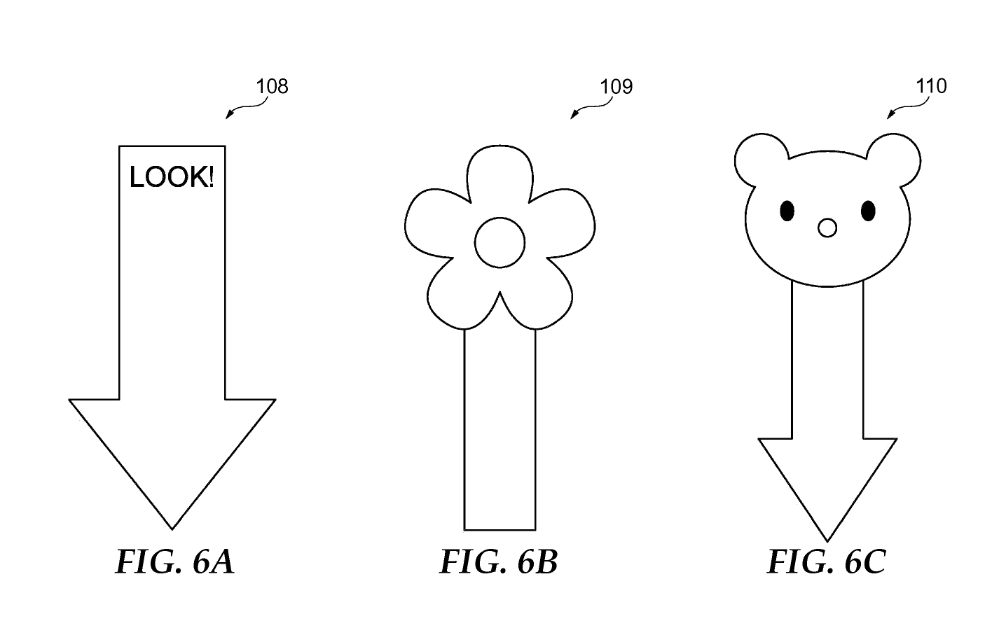

FIG. 6 shows the stretchable tape flag having a visual characteristic shape. In other words, FIG. 6A is a top view of the stretchable tape flag 108 according to the ninth embodiment which has a letter printed on one end of the backing layer, FIG. 6B is a top view of the stretchable tape flag 109 according to the tenth embodiment which has been formed to the shape of a flower on one end of the backing layer, and FIG. 6C is a top view of the stretchable tape flag 110 according to the eleventh embodiment which has been formed to the shape of an animal on one end of the backing layer. The stretchable tape flag which is shown in FIGS. 6A, 6B, and 6C should preferably have the part of a visual characteristic shape protruding from object and be applied on the object. Note that, the detachable adhesive layer can be formed on one side of the backing in any of the above described embodiments and a part or all of the backing layer can have plastic and deformation characteristics to allow the user to extend it easily by hand, and a primer layer can also be provided between backing layer and adhesive layer.

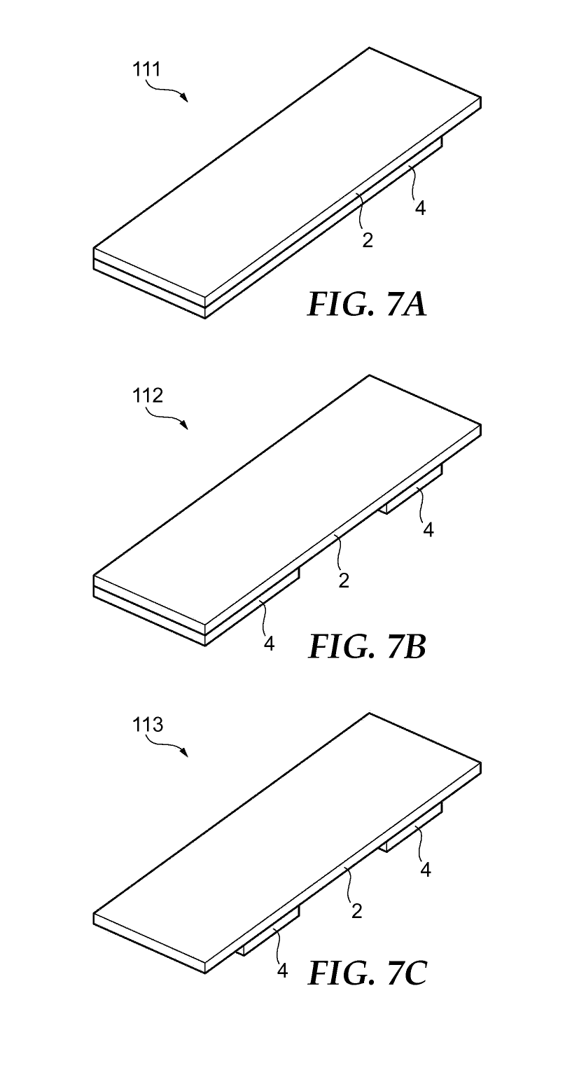

FIG. 7 shows when the adhesive layer is not formed over the entire surface of the backing layer. In other words, FIG. 7A is a perspective view showing the stretchable tape flag 111 according to the twelfth embodiment with the non-formed part of the adhesive layer 4 on the end of the backing 2. FIG. 7B is a perspective view showing the stretchable tape flag 112 according to the thirteenth embodiment, but in this embodiment, the adhesive layer 4 is divided and formed, and one side is formed to one end of backing layer 2, and the other side is formed to leave a part of the other end of the backing layer 2. FIG. 7C is a perspective view showing the stretchable tape flag 113 according to the fourteenth embodiment. In this embodiment, the adhesive layer 4 is divided and formed, and none of the adhesive layers 4 have been formed in an end of backing layer 2.

Hereinafter the backing layer, stretchable portion and an adhesive layer, which constitute the stretchable tape flag of the embodiments described above, will be described in detail.

In typical embodiments, the Young's modulus of the backing layer is less than about 500 MPa, preferably below about 345 MPa, and more preferably from about 4 to about 200 MPa. In this way, the stretchable tape flag does not bend easily due to the film hardness.

In addition, the tensile strength of the backing 2 less than 15 MPa is preferable, and the lengthwise break point should be about 50 to about 1200%, preferably about 150 to about 700%, and even more preferably about 350 to about 700%. By taking such a numerical value, it is possible to reach the reference point of an article or photograph located in the central portion of a magazine or an A-4 size document, or the like. If the stretchable portion of backing layer 2 has sufficient consistency for processing and handling, it may be any thickness, but a thickness in the range of about 10 μm to about 250 μm is preferable, since if it is too thick, it will cause a bad appearance or make the book or document bulky.

The backing layer 2, particularly the stretchable portion, is a single or co-polymer with an olefin or ethylene other than olefin unsaturated monomer and particularly materials which are non-extension, can be applied. High extendability and strength are easy to be provided by using non-extension materials. Polyolefin such as polyethylene, low density polyethylene, linear low-density polyethylene, polyethylene including a linear super-low-density polyethylene, polypropylene and the polybutylene, a vinyl co-polymers such as polyvinyl chloride or the polyvinyl acetate including in which neither of the materials have not been plasticized, an ethylene/meta chestnut rate co-polymer, an ethylene/vinyl acetate co-polymer, an acrylonitrile—butadiene—styrene co-polymer and olefin system co-polymer such as ethylene/propylene co-polymers, and an acrylic polymer and a co-polymer, or a combination of any of the above are given as the specific materials. A mixture or combination of plastic materials, or a mixture or combination plastic materials and elastomer materials, for example, polypropylene/polyethylene, polyurethane/polyolefin, and polyurethane/polycarbonate, polyurethane/polyester, may also be used.

The backing layer 2, particularly the stretchable portion, can be made from a single or multilayered film, a nonwoven film, a porous film, a foamed film, or a combination of any of these, and for example, it can be made from a film with a filler such as polyolefin containing calcium carbonate. The backing layer 2 should preferably be elected from either polyethylene film or polypropylene film, and the most favorable materials are a linear low-density polyethylene or a super low density polyethylene film.

The backing layer may be monolayer or multilayer as desired to optimize select performance criteria, e.g., color, transparency, writability, stiffness, flexability, thickness, etc.

The adhesive is preferably selected to be removable without damage or residue to the article.

An illustrative adhesive suitable for use herein comprises an alkyl (meth) acrylate monomer with at least one kind of alkyl group where the number of carbons is from 4 to 14, and a polymer with at least one kind of polarity comonomer, and it can be formed in a minute spherical adhesive. For example, the application weight of the dried adhesive of the adhesive layer 4 should preferably be about 0.2 g/m² to about 21 g/m². If it is a minute spherical adhesive material, it can flatten out easily and disperses comparatively uniformly and remains behind in the back side of the stretchable portion after being stretched, and its adhesive strength can be maintained.

Alkyl (meth) acrylate is isooctyl acrylate, 4-methyl-2-pentyl acrylate, 2-methylbutyl acrylate, isoamyl acrylate, sec-butyl acrylate, n-butyl acrylate, 2-ethyl hexyl acrylate, isodecyl meta acrylate, isononyl acrylate, and isodecyl acrylate are given as the alkyl (meth) acrylate monomer where the number of carbons of the alkyl group is from 4 to 14.

Acrylic acid, N-vinyl pyrrolidone, N-vinyl caprolactam, vinyl pyridine, methacrylic acid, acrylic amide, fumaric acid, itaconic acid, crotonate, acrylonitrile, methacryl nitril, hydroxyethyl acrylate, and hydroxyethyl meta acrylate are given as polar co-monomers. Note that, multi-functional monomer may be used together as well as the monomers described above and partial bridging structures may be formed.

For example, the average particle size of a minute spherical adhesive can be set to about 1 μm to about 100 μm. The average particle size of about 5 μm to about 80 μm is preferable, with about 30 μm to about 60 μm being more preferable. Forming the adhesive layer 4 with a minute spherical adhesive allows the adhesive to come in contact with the object at a single point or minute domain, and thereby improving the detachability (removability). Note that, U.S. Pat. Nos. 3,691,140, 3,858,731, 4,166,152, and 5,571,617 can be referenced with regards to the composition of the adhesive. Further, the primer layer may be provided appropriately to improve adhesive property between the backing layer and the adhesive layer.

Optional detachable liners to protect the adhesive layer 4 maybe used on stretchable tape flags of the invention. Those skilled in the art can readily select suitable materials with Kraft paper, polyethylene, polypropylene, polyester, or combinations of any of these materials being familiar examples. In other embodiments, a plurality of stretchable tape flags of the invention may be stacked to form a block. If desired, such blocks can be used with suitably adapted dispensers to permit easy removal of flags in one-by-one fashion.

### EXAMPLE

A stretchable tape flag was manufactured as follows. A polypropylene film “XP-4101” with a thickness of 57 um having a non-extension processed by inflation molding which is made by Aicello Chemical Co., Ltd., was used as the stretchable backing layer and the backing layer. 0.35 g/m² of a sensitive pressure adhesive called “spray paste 55” made by Sumitomo 3M Co., Ltd. was stuck on one surface of this backing layer to form the adhesive layer, and a stretchable tape flag was obtained.

The tensile strength, maximum tensile load, and breaking point test of the stretchable tape flag and backing layer (polypropylene film XP-4101) were measured according to JISK7127 (tensile speed: 50 mm/min). The specimen was cut out in the shape of the specimen 1B described in JISK7127 (the narrow portion of the center was 10 mm in width and 60 mm in length, and both ends were 20 mm in width and a full length of 150 mm, and in a shape of a dumbbell). The backing layer, regardless of having an adhesive layer or not, was less than 15 MPa and stretched more than 100%, as shown in Table 1. Further, when a stretchable tape flag 10 mm in width and 100 mm in length that was in accordance with the method shown in FIG. 4 stuck on a fine copying paper having a thickness of 0.65 g/m², the stretchable tape flag displayed an extension of more than 100%, and then it was detachably adhered to high-quality copying paper. Note that, the high-quality copying paper did not bend due to the strength of the stability of the backing layer. In other words, it could be confirmed that stretchable portion of the backing layer possessed the “plastic and deformation characteristics” after being extended and adhered. In addition, the words or characters printed on the high-quality copying paper could be read from the top of the applied stretchable tape flag.

TABLE 1

| | Maximum tensile | Tensile strength | Breaking point test |
|---|---|---|---|
| | load [N] | [Mpa] | [% GL] |
| Base layer only | 6.00 | 10.71 | >150 |
| Stretchable | 5.92 | 10.58 | >150 |
| tape flag | | | |

### REFERENCE NUMERALS KEY

2 Backing layer
2a End of the backing layer
2b Stretchable portion
4 Adhesive layer
6 Primer layer
10 Book
11 Article
12 Photograph
100 The stretchable tape flag according to the first embodiment
101 The stretchable tape flag according to the second embodiment
102 The stretchable tape flag according to the third embodiment
103 The stretchable tape flag according to the fourth embodiment
104 The stretchable tape flag according to the fifth embodiment
105 The stretchable tape flag according to the sixth embodiment
106 The stretchable tape flag according to the seventh embodiment
107 The stretchable tape flag according to the eighth embodiment
108 The stretchable tape flag according to the ninth embodiment
109 The stretchable tape flag according to the tenth embodiment
110 The stretchable tape flag according to the eleventh embodiment
111 The stretchable tape flag according to the twelfth embodiment
112 The stretchable tape flag according to the thirteenth embodiment
113 The stretchable tape flag according to the fourteenth embodiment

1-6. (canceled)

7. A stretchable tape flag comprising a backing layer having repositionable adhesive on at least a portion of side of the backing layer, wherein a portion of the backing layer is capable of being stretched by hand so as to increase the distance of one portion of the repositionable adhesive from another portion of the repositionable adhesive and wherein the repositionable adhesive maintains adhesive strength after the backing is stretched.

8. The stretchable tape flag according to claim 1 wherein the stretchable portion is capable of being stretched at least 100% in one direction

9. The stretchable tape flag according to claim 1 wherein the stress of the stretchable portion when being stretched 100% is less than about 15 MPa.

10. The stretchable tape flag according to claim 1 wherein the adhesive is in discontinuous portions wherein the portion of the backing layer between adhesive portions is capable of being stretched by hand.
